(19) United States
(12) Patent Application Publication
(10) Pub. No.: US 2006/0260120 A1
(43) Pub. Date: Nov. 23, 2006

(54) Method of making secondary battery

(75) Inventor: Tsung-Yao Chen, Taichung City (TW)

Correspondence Address: BROWDY AND NEIMARK, P.L.L.C.;624 NINTH STREET, NW, SUITE 300, WASHINGTON, DC, 20001-5303, US

(73) Assignee: EXA ENERGY TECHNOLOGY CO. LTD., Taichung (TW)

(21) Appl. No.: 11/132,377

(22) Filed: May 19, 2005

(51) Int. Cl. H01M 10/04

(52) U.S. Cl. 29/623.4

(57) ABSTRACT

A method of making a secondary battery includes the steps of a) providing a circuit board and a cell having a positive terminal and a negative terminal, b) bonding a first plate electrode and a second plate electrode to the circuit board, and c) connecting the cell to the circuit board by bonding the positive terminal to the first plate electrode and the negative terminal to the second plate electrode.

### BACKGROUND OF THE INVENTION

1. Field of the Invention

The present invention relates to a secondary battery and more particularly, to the method of making a secondary battery.

2. Description of the Related Art

A regular Li-polymer secondary battery is known comprised of a cell and a circuit board. The cell comprises an aluminum positive-pole electrode and a nickel negative-pole electrode. The positive-pole electrode and the negative-pole electrode are respectively soldered to the circuit board, thereby forming a battery for use in an electronic product. Because the positive-pole electrode of the Li-polymer secondary battery is made of aluminum, the surface of the positive-pole electrode will be oxidized in air, thereby forming a protective layer. The presence of such a protective layer may hinder bonding of the electrode to the circuit board. Therefore, during fabrication of a Li-polymer secondary battery, a nickel stem is bonded to the positive-pole electrode of the cell through an ultrasonic welding process, and then the cell and the circuit board are bonded together.

However, during the fabrication of the aforesaid Li-polymer secondary battery, it is difficult to bond the nickel stem to the aluminum positive-pole electrode by means of ultrasonic welding. Therefore, this conventional L-polymer secondary battery fabrication method cannot achieves a high productivity. Further, welding the nickel stem to the circuit board requires a high temperature, which may affect the performance of the battery, thereby increasing the defective rate and the manufacturing cost.

### SUMMARY OF THE INVENTION

The present invention has been accomplished under the circumstances in view. It is the main object of the present invention to provide a secondary battery fabrication method, which greatly increases the manufacturing speed and the yield rate, and saves much manufacturing cost.

To achieve this object of the present invention, the method of making secondary battery comprises the steps of a) providing a circuit board and a cell having a positive terminal and a negative terminal, b) bonding a first plate electrode and a second plate electrode to the circuit board, and c) connecting the cell to the circuit board by bonding the positive terminal to the first plate electrode and the negative terminal to the second plate electrode.

In a preferred embodiment, the first plate electrode and the second plate electrode are respectively bonded to the circuit board by surface mounting technique in step b). In addition, the cell and the circuit board are bonded together in step (c) by a method selected from a group consisting of spot welding, ultrasonic welding and high frequency welding. Further, the first plate electrode is preferably prepared from nickel aluminum alloy and the second plate electrode is preferably prepared from nickel.

### BRIEF DESCRIPTION OF THE DRAWINGS

FIG. 1 is schematic drawing showing the structure of a cell and a circuit board for a secondary battery according to the present invention.

FIG. 2 corresponds to FIG. 1, showing the cell and the circuit board bonded together.

### DETAILED DESCRIPTION OF THE INVENTION

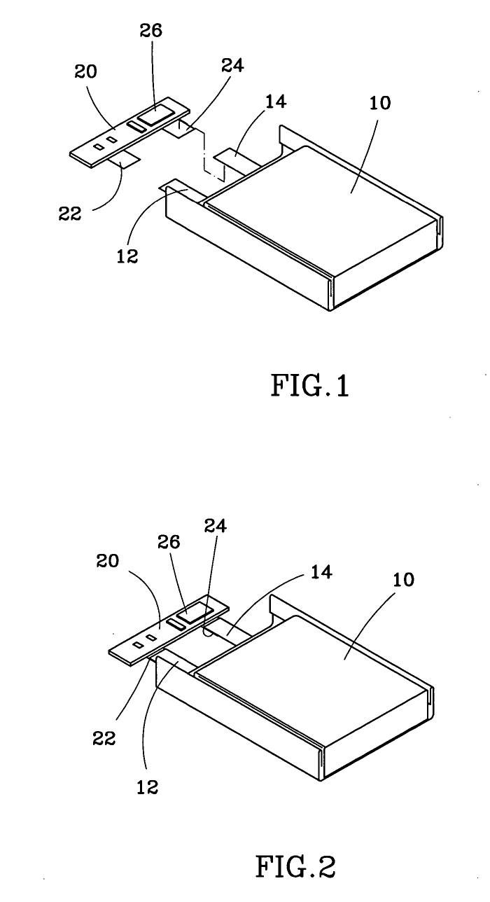

Referring to FIGS. 1 and 2, a secondary battery fabrication method in accordance with the present invention is shown comprising:

Step I: preparing a cell 10 from Li-polymer, which has a positive terminal 12 and a negative terminal 14, and a circuit board 20, which has a protection circuit 26 for overcharge protection;

Step II: bonding a first plate electrode 22, which is prepared from nickel aluminum alloy, and a second plate electrode 24, which is prepared from nickel, to the circuit board 20 by means of surface mounting technique (SMT); and

Step III: connecting the cell 10 to the circuit board 20 by spot welding to bond the positive terminal 12 to the first plate electrode 22 and the negative terminal 14 to the second plate electrode 24 respectively.

According to the aforesaid procedure, the first plate electrode 22 and the second plate electrode 24 are bonded to the circuit board 20 before connection of the circuit board 20 to the cell 10, the first plate electrode 22 of nickel aluminum alloy and the second plate electrode 24 of nickel can respectively easily be bonded to the positive terminal 12 and negative terminal 14 of the cell 10. Because bonding between the cell 10 and the circuit board 20 does not affect the performance of the cell 10, the yield rate of the present invention is high. Further, because the plate electrodes 22 and 24 are bonded to the circuit board 20 by means of SMT, the bonding procedure can be done at a high speed with less labor, thereby increasing the productivity and lowering the product cost.

Therefore, the secondary battery fabrication method of the present invention achieves a high manufacturing speed, increases the yield rate, and saves the manufacturing cost.

Further, During Step III, instead of the spot welding a high-frequency sealing or ultrasonic welding process may be employed to bond the circuit board and the cell together, achieving the same effect.

What is claimed is:

1. A method of making a secondary battery comprising the steps of:
(a) providing a circuit board and a cell having a positive terminal and a negative terminal;
(b) bonding a first plate electrode and a second plate electrode to said circuit board; and
(c) connecting said cell to said circuit board by bonding said positive terminal to said first plate electrode and said negative terminal to said second plate electrode respectively.

2. The method as claimed in claim 1, wherein said first plate electrode and said second plate electrode are respectively bonded to said circuit board by surface mounting technique in step (b).

3. The method as claimed in claim 1, wherein said cell and said circuit board are bonded together in step (c) by spot welding.

4. The method as claimed in claim 1, wherein said cell and said circuit board are bonded together in step (c) by ultrasonic welding.

5. The method as claimed in claim 1, wherein said cell and said circuit board are bonded together in step (c) by high frequency welding.

6. The method as claimed in claim 1, wherein said first plate electrode is prepared from nickel aluminum alloy.

7. The method as claimed in claim 1, wherein said second plate electrode is prepared from nickel.
